(19) United States
(12) Patent Application Publication
(10) Pub. No.: US 2025/0029099 A1
(43) Pub. Date: Jan. 23, 2025

(54) INTELLIGENT SYSTEM FOR VALIDATING DIGITAL ASSETS THROUGH POWER CONSUMPTION TELEMETRY TRACKING

(71) Applicant: BANK OF AMERICA CORPORATION, Charlotte, NC (US)

(72) Inventor: Shailendra Singh, Thane West (IN)

(73) Assignee: BANK OF AMERICA CORPORATION, Charlotte, NC (US)

(21) Appl. No.: 18/224,804

(22) Filed: Jul. 21, 2023

(51) Int. Cl. G06Q 20/40; G06Q 20/38

(52) U.S. Cl. CPC G06Q 20/401; G06Q 20/389

(57) ABSTRACT

Intelligent validation of digital resources through power consumption telemetry tracking. Power consumption telemetry data associated with a digital asset is extracted from distributed trust computing networks and the like and is subsequently applied to Artificial Intelligence, such as ML models to determine a power consumption indicator. Validation rules engine is executed, which selects validation rules based at least on digital asset type and applies, at least, the power consumption indicator to the selected validation rules to determine validation status. The validation status, which may be partially based on a minimal power consumption threshold, is determinative as to whether or not the digital asset is authorized for acceptance into a digital asset exchange platform.

### FIELD OF THE INVENTION

The present invention is related generally to digital assets and, more specifically, systems and methods for intelligent validation of digital assets through power consumption telemetry tracking.

### BACKGROUND

Digital assets, such Non-Fungible Tokens (NFTs) and cryptocurrencies are generated via energy intensive minting and/or mining operations. For example, the minting of NFTs or mining of cryptocurrency may involve a highly energy intensive Proof-of-Work (PoW) consensus mechanism used in distributed trust computing networks to achieve consensus and validate the minting or mining operation. In a PoW system, miners compete to solve a complex mathematical puzzle, known as a “hash puzzle,” in order to add a new block to a distributed ledger. However, the puzzle requires significant computational power and energy consumption to solve. The energy consumption required for mining/minting has raised environmental concerns, especially as the popularity and scale of digital assets have grown. Other factors, beside the consensus mechanism also play in part in defining the overall power consumption (commonly referred to as “carbon footprint”) required to mint or mine a digital asset. Such other factors may include, but are not limited to, the distributed trust computing network and the type of computing resources within the distributed trust computing network used to mint/mine the digital asset

Moreover, the geographic location of the distributed trust computing network may impact the overall power consumption/carbon imprint, in that, the geographic location (e.g., country or region) may define what types of regulations and rules are in place to limit power consumption or may define what type of power is used to mint/mine digital assets (e.g., coal (i.e., high carbon emissions) vs wind turbine (i.e., minimal carbon emissions) and the like).

Therefore, a need exists to develop systems, methods, computer program products that intelligently validate digital assets based on the amount of power consumed (i.e., carbon footprint) by the digital asset. The validation should not only consider the power consumed during the minting/mining of the digital asset but also power consumed post-minting/mining (e.g., power consumed for digital file storage, transferring digital asset from one distributed trust computing network to another and the like). The validation should ensure that only digital assets that meet minimal power consumption requirements are accepted by digital asset exchange platforms and that validated digital assets can be classified and tagged according to their respective power consumption/carbon footprint for purposes of managing subsequent exchanges involving the digital asset.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for intelligent validation of digital resources through power consumption telemetry tracking. In this regard, the present invention is capable of extracting, from distributed trust computing networks and the like, power consumption telemetry data associated with a digital asset. The telemetry data is related to the power consumed during the minting/mining of the digital asset and subsequent storage. In additional embodiments, in which the digital asset has been transferred from one distributed trust computing network to another, the telemetry data includes data related to the power consumed during the transfer process and at each distributed trust computing network.

Once the telemetry data has been extracted, Machine Learning (ML) models, in specific embodiments, Deep Learning (DL) models or the like are implemented, such that the telemetry data is applied to the ML/DL models to determine a power consumption indicator, such as a carbon footprint score or the like, for the digital asset.

Subsequently, a validation rules engine is executed, which selects validation rules based at least on digital asset type and applies, at least, the power consumption indicator to the selected validation rules to determine validation status. In additional embodiments other factors are applied to the rules, such as geographic location of the distributed trust computing network(s) or the like, to determine the validation status. The validation status, which may be partially based on a minimal power consumption threshold, is determinative as to whether or not the digital asset is authorized for acceptance into a digital asset exchange platform. In the event that the digital asset is capable of being validated, in specific embodiments of the invention, the digital asset exchange platform may classify and tag the digital asset according to levels of power consumption, so that subsequent exchanges involving the digital asset can be managed based on the classification and/or tagging.

A system for intelligently validating digital assets defines first embodiments of the invention. The system includes a first computing platform having a first memory and one or more first computing processor devices in communication with the first memory. The first memory stores digital asset telemetry extractor that is executable by at least one of the one or more first computing processor devices. The digital asset telemetry extractor is configured to extract telemetry data related to power consumed during minting or mining of a digital asset. The first memory further stores a digital asset power consumption evaluation engine including one or more machine learning models that is executable by at least one of the one or more first computing processor devices. The digital asset power consumption evaluation engine is configured to apply the extracted telemetry data to the one or more machine learning models to determine a power consumption indicator for the digital asset.

The system additionally includes a second computing platform having a second memory and one or more second computing processor devices in communication with the second memory. The second memory stores a validation rules engine including a plurality of validation rules that is executable by at least one of the one or more second computing processor devices. The validation rules engine is configured to select one or more of the plurality validation rules based at least on a type of the digital asset, apply at least the power consumption indicator to the selected one or more validation rules to determine a validation status of the digital asset. The validation status is one of (i) authorized for digital asset exchange platform ingestion, or (ii) unauthorized for digital asset exchange platform ingestion. In response to determining the validation status as authorized for digital asset exchange platform ingestion, generate a set of ingestion rules. The second memory further stores a digital asset ingestion module that is executable by at least one of the one or more second computing processor devices. The digital asset ingestion module is configured to execute the set of ingestion rules to receive the digital asset into a digit asset exchange platform.

In specific embodiments of the system, the digital asset telemetry extractor is further configured to extract the telemetry data related to power consumed during minting of a digital asset, including telemetry data associated with (i) a first distributed trust computing network used to mint the digital asset, (ii) type of consensus algorithm used to mint the digital asset, (iii) identification and type of nodes used to mint the digital asset, and (iv) geo-location of the first distributed trust computing network and nodes used to mint the digital asset. In other related specific embodiments of the system, the digital asset telemetry extractor is further configured to extract telemetry data related to power consumed during transfer of the digital asset, including telemetry data associated with (i) one or more secondary distributed trust computing networks to which the digital asset has been transferred, and (ii) one or more cross-bridges used to transfer the digital asset amongst the first distributed trust computing network and the one or more secondary distributed trust computing networks, (iii) type of consensus algorithms used to validate the digital asset at the one or more secondary distributed trust computing networks, (iv) identification and type of nodes used to validate the digital asset at the one or more secondary distributed trust computing networks, and (v) geo-location of the one or more secondary distributed trust computing network and nodes used to validate the digital asset at the one or more secondary distributed trust computing networks.

In further specific embodiments of the system, the digital asset telemetry extractor is further configured to extract telemetry data related to power consumed during mining of a digital asset, including telemetry data associated with (i) a first distributed trust computing network used to mine the digital asset, (ii) type of proof-of-work (PoW) algorithm used to mine the digital asset, (iii) identification and type of node used to mine the digital asset, and (iv) geo-location of the first distributed trust computing network and node used to mine the digital asset.

In additional specific embodiments of the system, the digital asset power consumption evaluation engine includes the one or more machine learning models at least one of which is a deep learning model comprising at least one chosen from the group consisting of knowledge graph, Natural Language Processing (NLP) and Generative Adversarial Network (GAN).

In further specific embodiments of the system, the digital asset power consumption evaluation engine is further configured to apply the extracted telemetry data to the one or more machine learning models which, in turn, maps the extracted telemetry data to weighted power consumption parameters that are aggregated to result in the power consumption indicator in a form of a power consumption score.

Moreover, in additional specific embodiments of the system, the validation rules engine is further configured to apply the power consumption indicator and other extracted telemetry data to the selected one or more validation rules to determine validation of the digital asset. The other extracted telemetry data includes at least one of geo-location of (i) a distributed trust computing network at which the digital asset has been minted or mined and (ii) nodes within the distributed trust computing network used to mint or mine the digital asset.

In additional specific embodiments of the system, the digital asset ingestion module is further configured to, in response to ingesting the digital asset into a digit asset exchange platform, classify the digital asset based on the power consumption indicator and assign an index tag based on the classification. In such embodiments of the system, the second memory further stores a digital asset management rules engine that is executable by at least one of the one or more second computing processor devices. The digital asset management rules engine configured to manage exchanges involving the digital asset based on the index tag assigned to the digital asset.

A computer-implemented method for intelligently validating digital assets defines second embodiments of the invention. The method being executable by one or more computing device processors. The method includes extracting telemetry data related to power consumed during minting or mining of a digital asset and applying the extracted telemetry data to one or more machine learning models to determine a power consumption indicator for the digital asset. Further, the computer-implemented method includes selecting one or more validation rules from amongst a plurality of validation rules based at least on a type of the digital asset and applying at least the power consumption indicator to the selected one or more validation rules to determine a validation status of the digital asset. The validation status is one of (i) authorized for digital asset exchange platform ingestion, or (ii) unauthorized for digital asset exchange platform ingestion. Further, the computer-implemented method includes, in response to determining the validation status as authorized for digital asset exchange platform ingestion, generating a set of ingestion rules and executing the set of ingestion rules to ingest the digital asset into a digit asset exchange platform.

In specific embodiments of the computer-implemented method, extracting the telemetry data further includes extracting the telemetry data including data associated with (i) a first distributed trust computing network used to mint the digital asset, (ii) type of consensus algorithm used to mint the digital asset, (iii) identification and type of nodes used to mint the digital asset, and (iv) geo-location of the first distributed trust computing network and nodes used to mint the digital asset. In other related embodiments of the computer-implemented method, extracting telemetry data further includes extracting the telemetry data related to power consumed during transfer of the digital asset including telemetry data associated with (i) one or more secondary distributed trust computing networks to which the digital asset has been transferred, and (ii) one or more cross-bridges used to transfer the digital asset amongst the first distributed trust computing network and the one or more secondary distributed trust computing networks, (iii) type of consensus algorithms used to validate the digital asset at the one or more secondary distributed trust computing networks, (iv) identification and type of nodes used to validate the digital asset at the one or more secondary distributed trust computing networks, and (v) geo-location of the one or more secondary distributed trust computing network and nodes used to validate the digital asset at the one or more secondary distributed trust computing networks.

In additional specific embodiments of the computer-implemented method, applying the extracted telemetry data to the one or more machine learning models further includes mapping the extracted telemetry data to weighted power consumption parameters and aggregating the weighted power consumption parameters to result in the power consumption indicator in a form of a power consumption score.

Moreover, further specific embodiments of the computer-implemented method include, in response to ingesting the digital asset into a digit asset exchange platform, classifying the digital asset based on the power consumption indicator and assigning an index tag based on the classification. In related embodiments, the computer-implemented method further includes managing exchanges involving the digital asset based on the index tag assigned to the digital asset.

A computer program product including a non-transitory computer-readable medium defines third embodiments of the invention. The computer-readable medium includes sets of codes for causing one or more computing devices to extract telemetry data related to power consumed during minting or mining of a digital asset and apply the extracted telemetry data to one or more machine learning models to determine a power consumption indicator for the digital asset. The sets of codes further cause the computing device(s) to select one or more validation rules from amongst a plurality of validation rules based at least on a type of the digital asset and apply at least the power consumption indicator to the selected validation rule(s) to determine a validation status of the digital asset. The validation status is one of (i) authorized for digital asset exchange platform ingestion, or (ii) unauthorized for digital asset exchange platform ingestion. Moreover, the sets of codes further cause the computing device(s) to, in response to determining the validation status as authorized for digital asset exchange platform ingestion, generate a set of ingestion rules and execute the set of ingestion rules to ingest the digital asset into a digit asset exchange platform.

In specific embodiments of the computer program product, the set of codes for causing the one or more computing devices to extract telemetry data related to power consumed during minting or mining of a digital asset are further configured to cause the one or more computing devices to extract the telemetry data including telemetry data associated with (i) a first distributed trust computing network used to mint the digital asset, (ii) type of consensus algorithm used to mint the digital asset, (iii) identification and type of nodes used to mint the digital asset, and (iv) geo-location of the first distributed trust computing network and nodes used to mint the digital asset. In related specific embodiments of the computer program product, the set of codes for causing the one or more computing devices to extract telemetry data are further configured to cause the one or more computing devices to extract the telemetry data related to power consumed during transfer of the digital asset including telemetry data associated with (i) one or more secondary distributed trust computing networks to which the digital asset has been transferred, and (ii) one or more cross-bridges used to transfer the digital asset amongst the first distributed trust computing network and the one or more secondary distributed trust computing networks, (iii) type of consensus algorithms used to validate the digital asset at the one or more secondary distributed trust computing networks, (iv) identification and type of nodes used to validate the digital asset at the one or more secondary distributed trust computing networks, and (v) geo-location of the one or more secondary distributed trust computing network and nodes used to validate the digital asset at the one or more secondary distributed trust computing networks.

In other specific embodiments of the computer program product, the set of codes for causing the one or more computing devices to apply the extracted telemetry data to the one or more machine learning models are further configured to cause the one or more computing devices to map the extracted telemetry data to weighted power consumption parameters and aggregate the weighted power consumption parameters to result in the power consumption indicator in a form of a power consumption score.

Moreover, in additional specific embodiments of the computer program product, the sets of codes further include a set of codes for causing the one or more computing devices to, in response to ingesting the digital asset into a digit asset exchange platform, classify the digital asset based on the power consumption indicator and assign an index tag based on the classification and manage exchanges involving the digital asset based on the index tag assigned to the digital asset.

Thus, according to embodiments of the invention, which will be discussed in greater detail below, the present invention provides for intelligent validation of digital resources through power consumption telemetry tracking. In this regard, the present invention is capable of extracting, from distributed trust computing networks and the like, power consumption telemetry data associated with a digital asset. The extracted power consumption telemetry data is applied to ML models to determine a power consumption indicator. Subsequently, a validation rules engine is executed, which selects validation rules based at least on digital asset type and applies, at least, the power consumption indicator to the selected validation rules to determine validation status. The validation status, which may be partially based on a minimal power consumption threshold, is determinative as to whether or not the digital asset is authorized for acceptance into a digital asset exchange platform. In the event that the digital asset is capable of being validated, in specific embodiments of the invention, the digital asset exchange platform may classify and tag the digital asset according to levels of power consumption, so that subsequent exchanges involving the digital asset can be managed based on the classification and/or tagging.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for intelligent validation of digital assets through power consumption telemetry tracking, in accordance with embodiments of the present invention;

FIG. 2 is schematic/block diagram of a system for power consumption telemetry tracking including transfer of a digital asset amongst different distributed trust computing networks; in accordance with embodiments of the present invention;

FIG. 3 is a block diagram of a computing platform including a digital asset telemetry data extractor, in accordance with embodiments of the present invention;

FIG. 4 is a block diagram of a computing platform including digital asset power consumption evaluator, in accordance with embodiments of the present invention;

FIG. 5 is a block diagram of a computing platform including a validation rules engine, a digital asset ingestion module and a digital asset management engine, in accordance with embodiments of the present invention; and

FIG. 6 is a flow diagram of a method for intelligent validation of digital assets through power consumption telemetry tracking, in accordance with embodiments of the present invention.

FIG. 7 is a schematic/block diagram of a system for intelligent minting of digital assets with power consumption optimization, in accordance with embodiments of the present invention;

FIG. 8 is schematic/block diagram of an alternate system for intelligent minting of digital assets with power consumption optimization, in accordance with embodiments of the present invention;

FIG. 9 is a block diagram of a computing platform including a digital file metadata extractor and a digital asset power consumption optimization engine, in accordance with embodiments of the present invention;

FIG. 10 is a flow diagram of a method for intelligent minting of digital assets with power consumption optimization, in accordance with embodiments of the present invention;

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that providing for intelligent validation of digital resources through power consumption telemetry tracking. In this regard, the present invention is capable of extracting, from distributed trust computing networks and the like, power consumption telemetry data associated with a digital asset. The telemetry data is related to the power consumed during the minting/mining of the digital asset and subsequent storage, including distributed trust computing network, network resources in the distributed trust computing network, minting/mining application, consensus application and the like. In additional embodiments, in which the digital asset has been transferred from one distributed trust computing network to another, the telemetry data includes data related to the power consumed during the transfer process (e.g., cross bridge/smart contract and the like) and at each distributed trust computing network.

Once the power consumption telemetry data has been extracted, Machine Learning (ML) models, in specific embodiments, Deep Learning (DL) models or the like are implemented, such that the telemetry data is applied to the ML/DL models to determine a power consumption indicator, such as a power consumption/carbon footprint score or the like, for the digital asset.

Subsequently, a validation rules engine is executed, which selects validation rules based at least on digital asset type and applies, at least, the power consumption indicator to the selected validation rules to determine validation status. In additional embodiments other factors are applied to the rules, such as geographic location of the distributed trust computing network(s) and/or nodes in the distributed trust computing network or the like, to determine the validation status. The validation status, which may be partially based on a minimal power consumption threshold, is determinative as to whether or not the digital asset is authorized for acceptance into a digital asset exchange platform. In the event that the digital asset is capable of being validated, in specific embodiments of the invention, the digital asset exchange platform may classify and tag the digital asset according to levels of power consumption, so that subsequent exchanges involving the digital asset can be managed based on the classification and/or tagging.

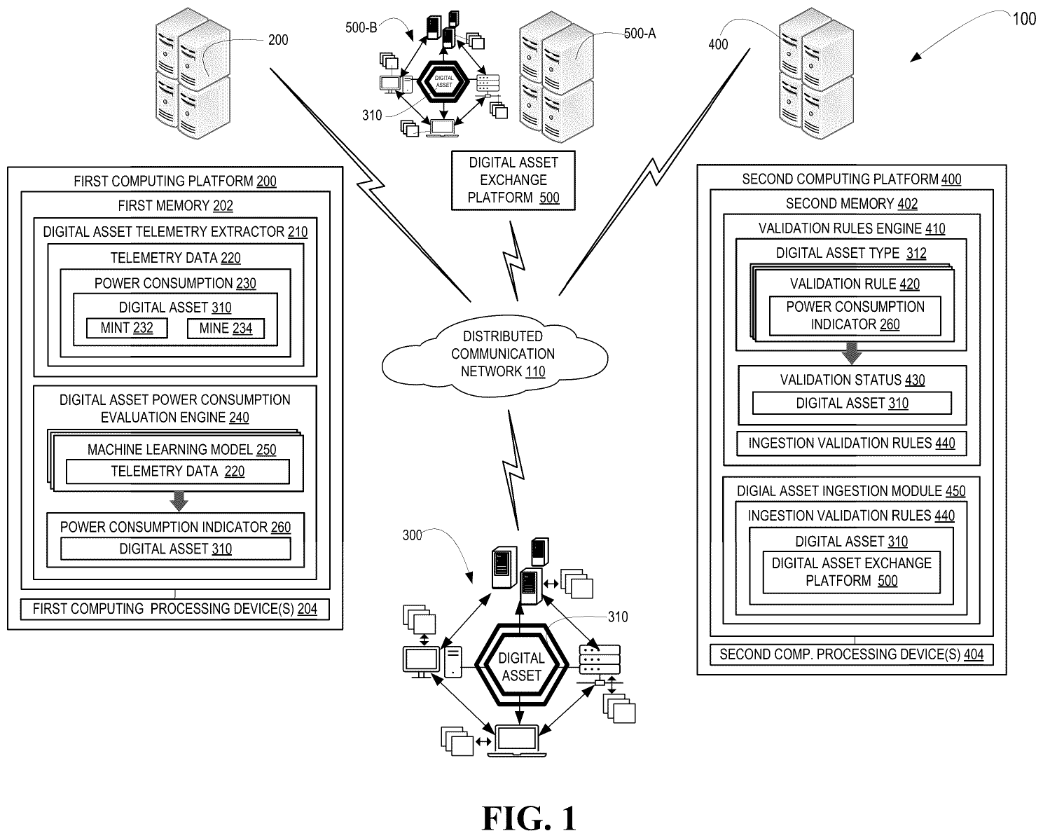

Referring to FIG. 1, a schematic/block diagram is presented of a system 100 for intelligent validation of digital assets via power consumption telemetry tracking, in accordance with embodiments of the invention. The system 100 includes first computing platform 200, which may comprise one or more application servers or the like. First computing platform 200 includes first memory 202 and one or more first computing processing devices 204 in communication with first memory 202. First memory 202 stores digital asset telemetry data extractor 210 that is executable by at least one of the first computing device processor(s) 204. Digital asset telemetry data extractor 210 is configured to extract telemetry data 220 related to the power consumption 230, commonly referred to as “carbon footprint” of a digital asset 310 (e.g., Non-Fungible Token (NFT), cryptocurrency or the like) during, at least the minting 232 or mining 234 of the digital asset 310. In this regard, telemetry data 220 is extracted from, at least, the distributed trust computing network 300, commonly referred to a “blockchain network” at which the digital asset 310 is minted 232, mined 234 and/or stored.

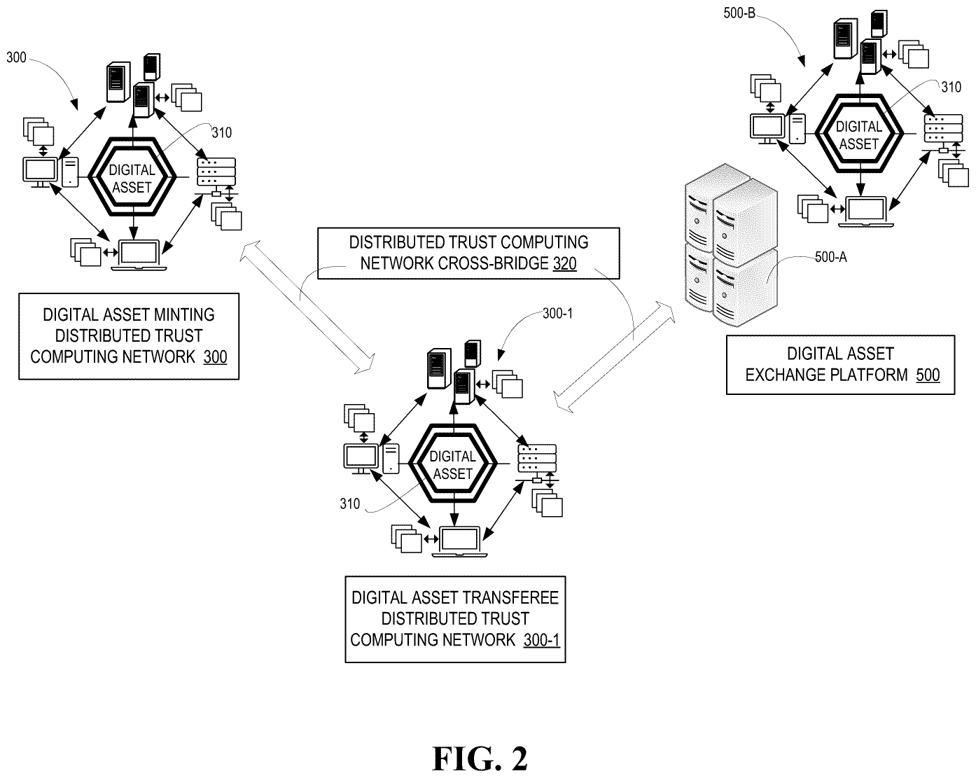

First memory 202 additionally stores digital asset power consumption evaluation engine 240, which includes one or more machine-learning (ML) models 250. In specific embodiments of the invention, the machine-learning (ML) model(s) 250 are deep-learning (DL) models. Digital asset power consumption evaluation engine 240 is executable by at least one of the one or more first computing processor devices 204 and is configured to apply the extracted telemetry data 220 to the one or more machine learning models 250 to determine a power consumption indicator 260 for the digital asset 310. The power consumption indicator 260 indicates a level or amount of power consumed by the digital asset 310 during, at least, the minting 232/mining 234 of the digital asset 234 and, in some embodiments of the system, the entire lifecycle of the digital assets, including transfers of the digital asset 310 to other distributed trust computing networks 300, as described infra. in relation to FIG. 2.

The system 100 additionally includes second computing platform 400, which may comprise one or more application servers or the like. Second computing platform 400 includes second memory 402 and one or more second computing processing devices 404 in communication with second memory 402. Second memory 402 stores validation rules engine 410 that is executable by at least one of the one or more second computing processor devices 404. Validation rules engine 410 includes a plurality of validation rules 420 and is configured to select the appropriate validation rules 420 from amongst the plurality of validation rules 420 based, at least, on digital asset type 312. In response to validation rules 420 selection, validation rules engine 410 is configured to apply, at least, the power consumption indicator 260 to the selected one or more validation rules 420 to determine a validation status 430 for the digital asset 310. The validation status 430 is one of (i) authorized for digital asset exchange platform 500 ingestion, or (ii) unauthorized for digital asset exchange platform 500 ingestion. In response to determining that the validation status 430 is (i) authorized for digital asset exchange platform 500 ingestion, validation rules engine 410 is further configured to generate a set of ingestion validation rules 440, commonly referred to a “smart contract”.

Second memory 402 additionally stores digital asset ingestion module 450 that is executable by at least one of the one or more second computing processor devices 404 and is configured to execute the set of ingestion rules 440 (i.e., the “smart contract”) to receive and validate the digital asset 310 into a digit asset exchange platform 500. In specific embodiments of the system 100, digit asset exchange platform 500 may be a financial institution platform or the like. As shown in FIG. 1 digit asset exchange platform 500 may include applications servers 500-A and distributed trust computing network 500-B configured to store or provided access to digital asset 310. Application servers 500-A and distributed trust computing network 500-B are configured to work in unison to manage exchanges, such as transactions, involving the digital asset 310.

Referring to FIG. 2, a schematic diagram is depicted of transfer of a digital asset 310 amongst different distributed trust computing networks prior to ingestion of the digital asset into the digital asset exchange platform 500. In such embodiments of the system 100, shown and described in FIG. 1, since the transfer to the digital asset 310 amongst different distributed trust computing networks consumes power, the telemetry data 220 extracted by the digital asset telemetry data extractor 200 includes telemetry data 220 associated with the transfer of the digital asset 310, including the distributed trust computing network cross-bridges 320 used as transfer mechanisms and the digital asset transferee distributed trust computing network 300-1 to which the digital asset is transferred. Transfer of the digital asset 310 from one distributed trust computing network 300 to another distributed trust computing network 300-1 may occur as a result of a digital asset exchange/transaction or may occur without an actual exchange/transaction. It should also be noted that while FIG. 2 only depicts one transfer of the digital asset 310, one of ordinary skill in the art will appreciate that the digital asset 310 may undergo multiple transfers to multiple different digital trust computing networks 300 prior to the digital asset 310 being ingested/transferred into the digital asset exchange platform 500.

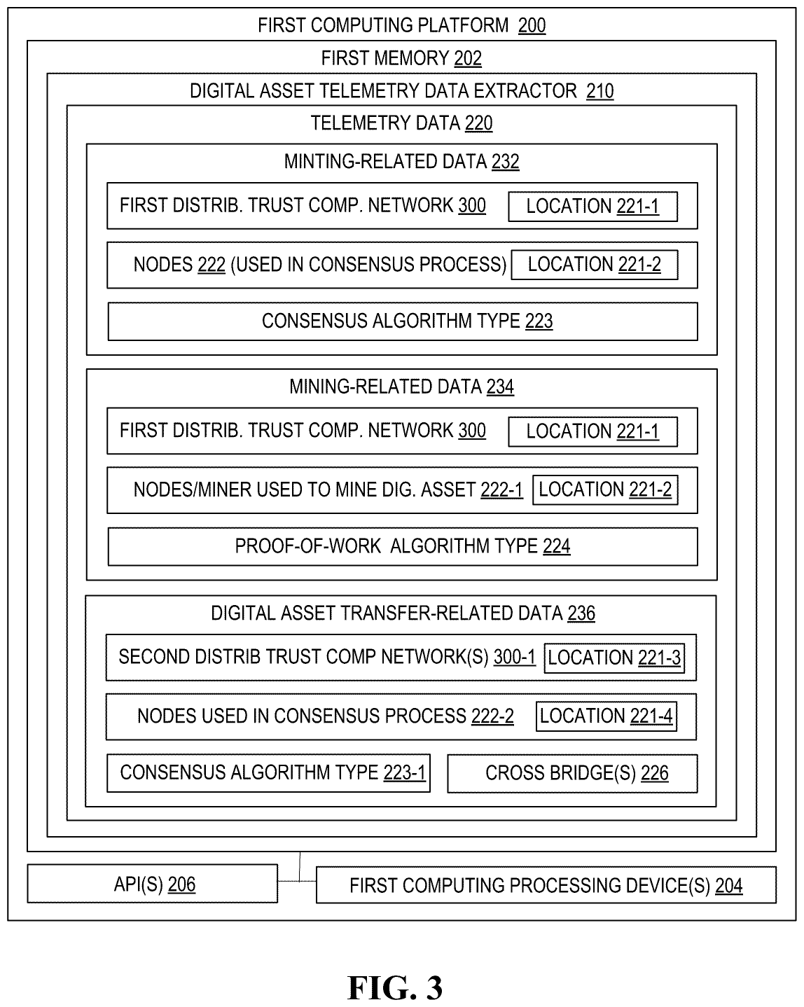

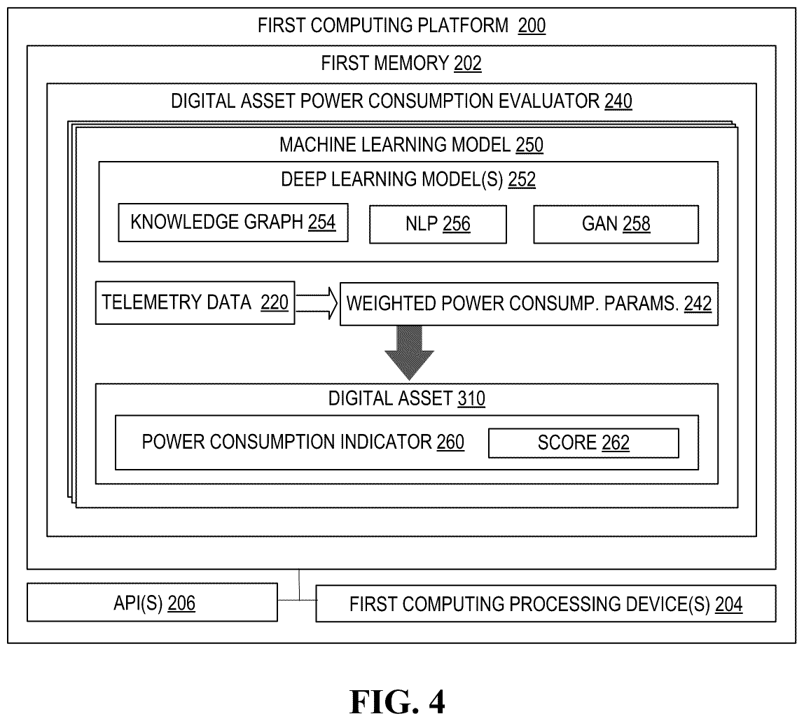

Referring to FIGS. 3 and 4, block diagrams are presented of first computing platform 200, in accordance with embodiments of the present invention. In addition to providing greater details of digital telemetry data extractor 210, FIG. 3 highlights various alternate embodiments of the invention. First computing platform 200 may comprise one or multiple devices, such as application servers or the like. First computing platform 200 includes first memory 202, which may comprise volatile and/or non-volatile memory, such as read-only and/or random-access memory (RAM and ROM), EPROM, EEPROM, flash cards, or any memory common to computing platforms). Moreover, first memory 202 may comprise cloud storage, such as provided by a cloud storage service and/or a cloud connection service.

Further, first computing platform 200 includes one or more first computing processing devices 204, which may be an application-specific integrated circuit (“ASIC”), or other chipset, logic circuit, or other data processing device. First computing processing device(s) 204 may execute one or more application programming interface (APIs) 206 that interface with any resident programs, such as digital asset telemetry data extractor 210, digital asset power consumption evaluation engine 240 or the like, stored in first memory 202 of first computing platform 200 and any external programs. First computing processing devices(s) 204 may include various processing subsystems (not shown in FIGS. 3 and 4) embodied in hardware, firmware, software, and combinations thereof, that enable the functionality of first computing platform 200 and the operability of first computing platform 200 on a distributed communication network 110 (shown in FIG. 1), such as the Internet, intranet(s), cellular network(s) and the like. For example, processing subsystems allow for initiating and maintaining communications and exchanging data with other networked devices. For the disclosed aspects, processing subsystems of first computing platform 200 may include any subsystem used in conjunction with digital asset telemetry data extractor 210 and digital asset power consumption evaluation engine 240 and related tools, routines, sub-routines, algorithms, sub-algorithms, sub-modules thereof.

In specific embodiments of the present invention, first computing platform 200 additionally includes a communications module (not shown in FIGS. 3 and 4) embodied in hardware, firmware, software, and combinations thereof, that enables electronic communications between components of first computing platform 200 and other networks and network devices. Thus, communication module may include the requisite hardware, firmware, software and/or combinations thereof for establishing and maintaining a network communication connection with one or more devices and/or networks.

As discussed in FIG. 1, first memory 202 of first computing platform 200 stores digital asset telemetry data extractor 210, which is executable by at least one of the one or more first computing processor devices 204. As previously discussed in relation to FIG. 1, digital asset telemetry data extractor 210 is configured to extract telemetry data 220 related to power consumption 230 (i.e., carbon footprint) occurring, at least during minting 232 or mining 234 of the digital asset 310. Minting 232-related telemetry data 220 may include, but is not limited to, the first distributed trust computing network 300 used to mint/validate the digital asset 310 and the geo-location 221-1 (e.g., country or regions within a country) of the first distributed trust computing network 300. Further, minting 232-related telemetry data 220 may include the nodes 222 used in the consensus/validation process, the geo-location 221-2 (e.g., country or regions within a country) of the nodes 222 and the consensus algorithm type 223 used in the consensus/validation process.

Mining 234-related telemetry data 220 may include, but is not limited to, the first distributed trust computing network 300 used to mine the digital asset 310 and the geo-location 221-1 (e.g., country or regions within a country) of the first distributed trust computing network 300. Further, mining 234-related telemetry data 220 may include the nodes 222-1 and/or miner used in mining and/or proof-of-work process, the geo-location 221-2 (e.g., country or regions within a country) of the nodes 222-1 and the proof-of-work (PoW) algorithm type 224 used in the proof of work/validation process.

In specific embodiments of the system, in which the digital asset has been transferred from one distributed trust computing network to another, telemetry data 220 includes digital asset transfer-related telemetry data 236. Digital asset transfer-related telemetry data 236 may include, but is not limited to, the second (i.e., transferee) distributed trust computing network 300-1 and the geo-location 221-3 (e.g., country or regions within a country) of the second distributed trust computing network 300-1. Further, digital asset transfer-related telemetry data 236 may include the nodes 222-2 used in the consensus/validation process, the geo-location 221-4 (e.g., country or regions within a country) of the nodes 222-2, the consensus/validation algorithm type 223-1 used in the consensus/validation process and the cross-bridges(s) 226 used as the transfer mechanism.

In addition to providing greater details of digital asset power consumption evaluator 240, FIG. 4 highlights various alternate embodiments of the invention. As discussed in FIG. 1, first memory 202 of first computing platform 200 stores digital asset power consumption evaluator 240, which is executable by at least one of the one or more first computing processor devices 204. Digital asset power consumption evaluator 240 includes one or more machine-learning (ML) models 250. In specific embodiments of the invention, the machine-learning (ML) model(s) 250 are deep-learning (DL) models 252, such as, but not limited to, knowledge graph 254, Natural Language Processing (NLP) 256, Generative Adversarial Network (GAN) 258 or the like. Digital asset power consumption evaluation engine 240 is executable by at least one of the one or more first computing processor devices 204 and is configured to apply the extracted telemetry data 220 to the one or more machine learning models 250 to determine a power consumption indicator 260 for the digital asset 310. In specific embodiments of the system, telemetry data 220 is mapped to weighted power consumption parameters 242 which result in the power consumption indicator 260. Specifically, weighted power consumption parameters 242 are summed to result in a power consumption score 262 that indicates the level of power consumed by the digital asset 310 during minting/mining, storage and, where applicable, transfer of the digital asset 310.

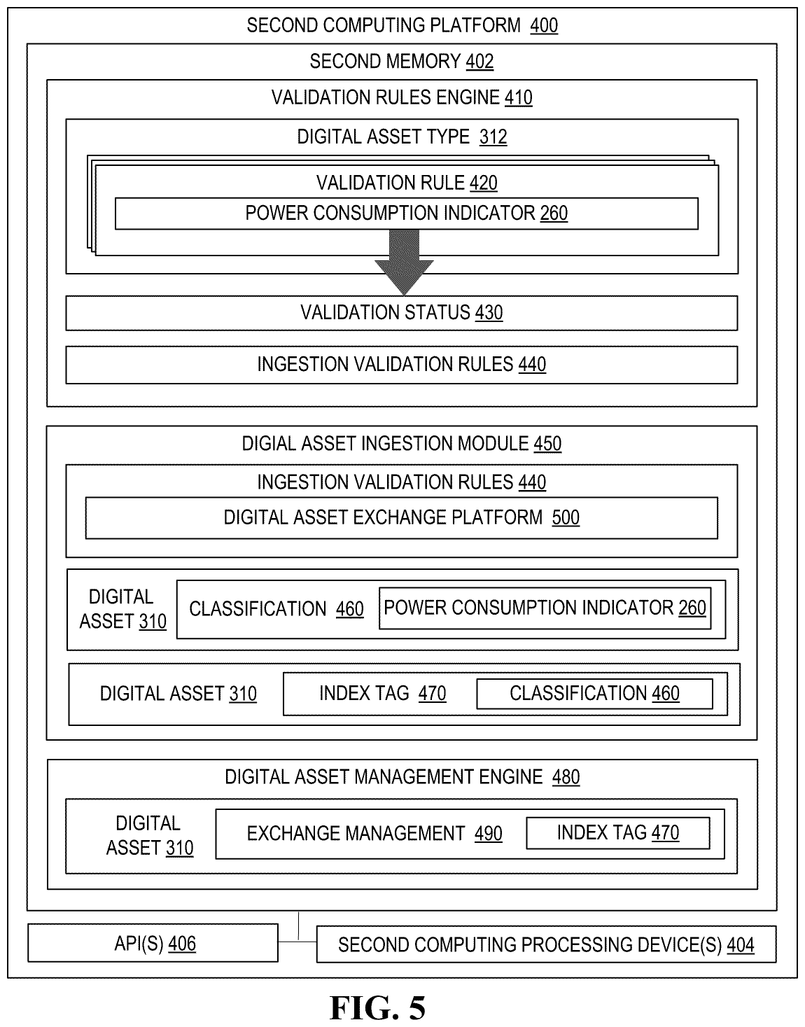

Referring to FIG. 5, a block diagram is presented of second computing platform 400, in accordance with embodiments of the present invention. In addition to providing greater details of validation rules engine 410 and digital asset ingestion module 450, FIG. 5 highlights various alternate embodiments of the invention. Second computing platform 400 may comprise one or multiple devices, such as application servers or the like. Second computing platform 400 includes second memory 402, which may comprise volatile and/or non-volatile memory, such as read-only and/or random-access memory (RAM and ROM), EPROM, EEPROM, flash cards, or any memory common to computing platforms). Moreover, second memory 402 may comprise cloud storage, such as provided by a cloud storage service and/or a cloud connection service.

Further, second computing platform 400 includes one or more second computing processing devices 404, which may be an application-specific integrated circuit (“ASIC”), or other chipset, logic circuit, or other data processing device. Second computing processing device(s) 404 may execute one or more application programming interface (APIs) 406 that interface with any resident programs, such as validation rules engine 410, digital asset ingestion module 450, digital asset management engine 480 or the like, stored in second memory 402 of second computing platform 400 and any external programs. Second computing processing devices(s) 404 may include various processing subsystems (not shown in FIG. 5) embodied in hardware, firmware, software, and combinations thereof, that enable the functionality of second computing platform 400 and the operability of second computing platform 400 on a distributed communication network 110 (shown in FIG. 1), such as the Internet, intranet(s), cellular network(s) and the like. For example, processing subsystems allow for initiating and maintaining communications and exchanging data with other networked devices. For the disclosed aspects, processing subsystems of second computing platform 400 may include any subsystem used in conjunction with validation rules engine 410, digital asset ingestion module 450, digital asset management engine 480 and related tools, routines, sub-routines, algorithms, sub-algorithms, sub-modules thereof.

In specific embodiments of the present invention, second computing platform 400 additionally includes a communications module (not shown in FIG. 5) embodied in hardware, firmware, software, and combinations thereof, that enables electronic communications between components of second computing platform 400 and other networks and network devices. Thus, communication module may include the requisite hardware, firmware, software and/or combinations thereof for establishing and maintaining a network communication connection with one or more devices and/or networks.

As discussed in relation to FIG. 1, second memory 402 stores validation rules engine 410 that is configured to includes a plurality of validation rules 420 and is configured to select the appropriate validation rules 420 from amongst the plurality of validation rules 420 based, at least, on digital asset type 312. In response to validation rules 420 selection, validation rules engine 410 is configured to apply, at least, the power consumption indicator 260 to the selected one or more validation rules 420 to determine a validation status 430 for the digital asset 310. The validation status 430 is one of (i) authorized for digital asset exchange platform 500 ingestion, or (ii) unauthorized for digital asset exchange platform 500 ingestion. In specific embodiments of the system, geo-locations of distributed trust computing network(s) and/or nodes of the distributed trust computing network(s) are also applied to the selected validation rules 420 to determine validation status 430. In one such example, the selected validation rules 420 may grant a validation status of (ii) unauthorized for digital asset exchange platform 500 ingestion, if the distributed trust computing network is located in a specific country or region or, in another example, the selected validation rules 420 may allow validation status (i) authorized for digital asset exchange platform 500 ingestion, if the power consumption indicator indicates a high level of power consumption but the distributed trust computing network is located in a specific preferred country or region that uses a high amount of non-fossil fuel energy. In response to determining that the validation status 430 is (i) authorized for digital asset exchange platform 500 ingestion, validation rules engine 410 is further configured to generate a set of ingestion validation rules 440, commonly referred to a “smart contract”.

Second memory 402 additionally stores digital asset ingestion module 450 that is executable by at least one of the one or more second computing processor devices 404 and is configured to execute the set of ingestion rules 440 (i.e., the “smart contract”) to receive and validate the digital asset 310 into a digit asset exchange platform 500. In specific embodiments of the system 100, digit asset exchange platform 500 may be a financial institution platform or the like. In specific embodiments of the system, digital asset ingestion module 450 is further configured to assign a one of a plurality of classifications 460 to the digital asset based on the power consumption indicator and, in other specific embodiments provide an index tag 470 to the digital asset 310 based on the assigned classification 460. The index tag 470 being “attached” to the digital asset 310 will remain with the digital asset in the event the digital asset 310 undergoes an exchange/transaction or is transferred to another digital trust computing network.

In other embodiments of the system, second memory 404 additionally stores digital asset management engine 480 which is executable by at least one of the one or more second computing processor devices 404 and configured to perform exchange/transaction management 490 of the digital asset 310 in accordance with an index tag 470. In this regard, digital asset management engine 480 is executed once a digital asset 310 has been validated and ingested into the digital asset exchange platform 500. Moreover, exchange/transaction management 490 means that subsequent exchanges/transactions involving the digital 550 may be authorized or denied based on the index tag 470 (i.e., classification 460 assigned to the digital asset 310).

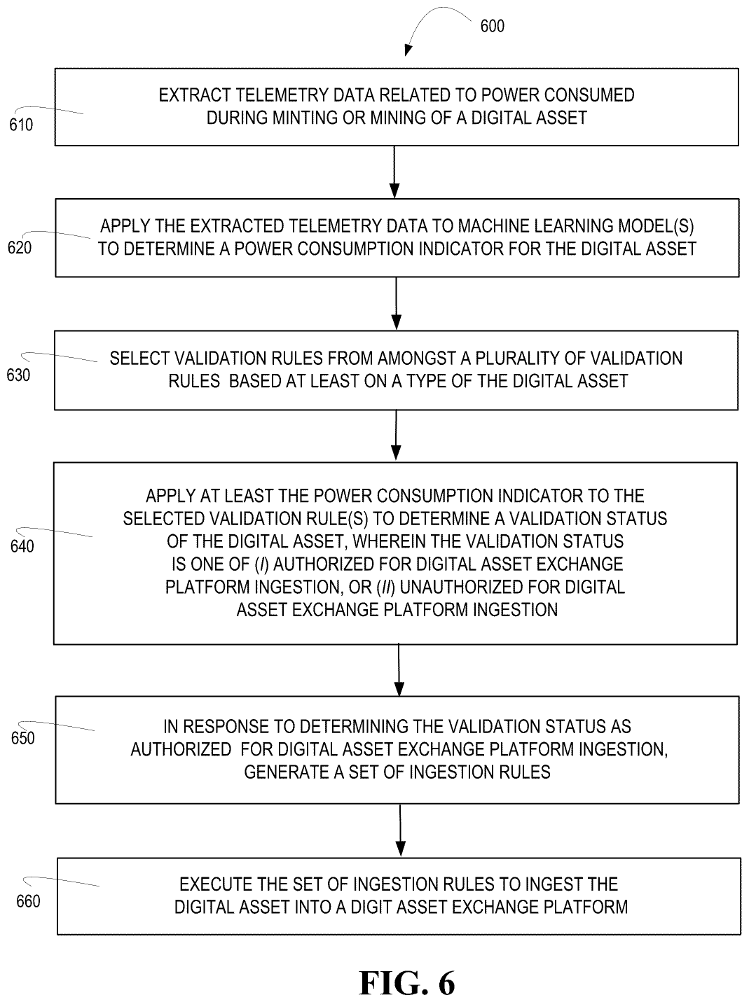

Referring to FIG. 6, a flow diagram is presented of method 600 for intelligent validation of digital assets via power consumption telemetry data tracking, in accordance with embodiments of the present invention. At Event 610, telemetry data is extracted from a digital asset or distributed trust computing network used to mint/mine and/or store the digital asset. The telemetry data is related to power consumption (i.e., the carbon footprint of the digital asset) of the digital asset occurred in minting/mining of the digital asset, storage of the asset and, in some embodiments, where applicable transfer of the digital asset amongst different distributed trust computing networks.

At Event 620, the extracted telemetry data is applied to ML algorithms, in specific embodiments, DL algorithms to determine a power consumption indicator for the digital asset. The power consumption indicator, which may be a numeric score or the like indicates the level of power consumed by the digital asset when minting/mining, storing and transferring the digital asset.

In response to determining the power consumption indicator, at Event 630, validation rules are selected from amongst a plurality of validation rules based, at least, on the type of digital asset and, at Event 640, at least the power consumption indicator (and, in some embodiments of the invention geo-location of distributed trust computing networks and/or nodes) are applied to the validation rules to determine a validation status. The validation may include (i) authorized for digital asset exchange platform ingestion, or (ii) unauthorized for digital asset exchange platform ingestion.

In response to determining that the validation status is (i) authorized for digital asset exchange platform ingestion, at Event 650, a set of ingestion rules (i.e., a “smart contract”) is generated and, at Event 660, the ingestion rules are executed to ingest the digital asset into a digital asset exchange platform, such as a financial institution's NFT or cryptocurrency transaction platform.

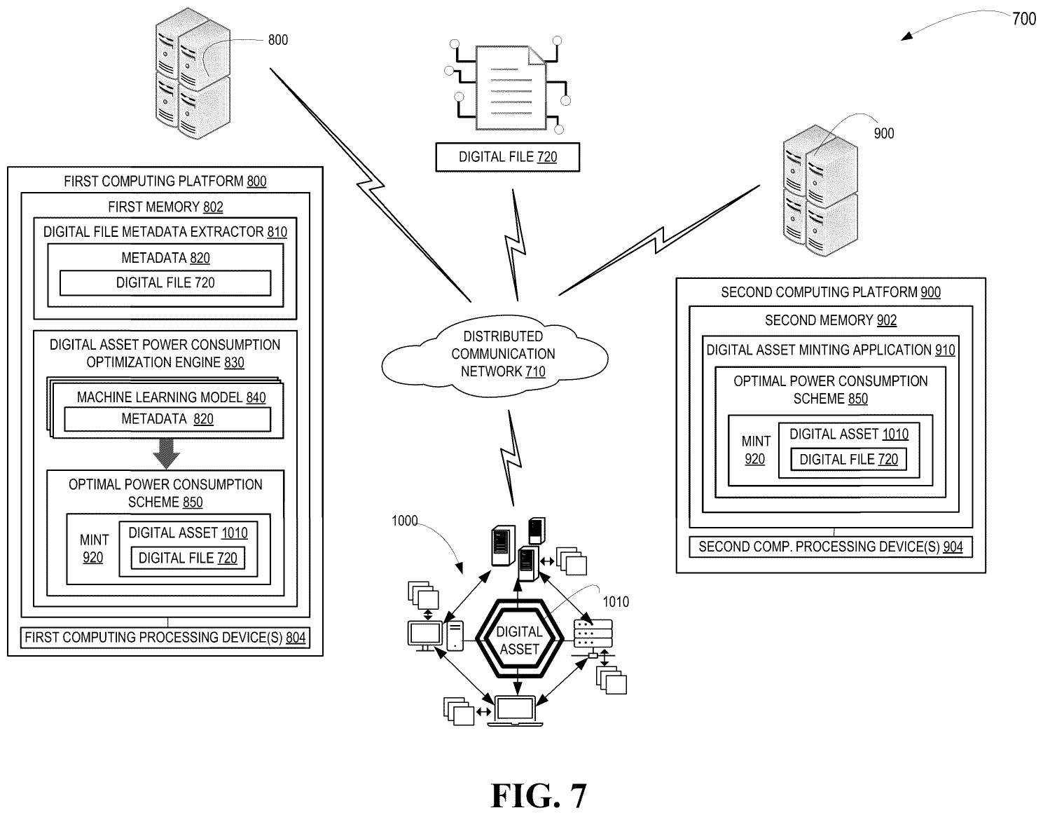

Referring to FIG. 7, a schematic/block diagram is presented of a system 700 for minting digital assets, such as Non-Fungible Tokens (NFTs) with power consumption optimization (e.g., so-called “carbon footprint” optimization), in accordance with embodiments of the present invention. System 700 is implemented in a distributed communication network, which may comprise the Intranet, one or more internets, one or more cellular networks or the like. System 700 includes first computing platform 800, which includes first memory 802 and one or more first computing device processors 804 in communication with first memory 802. First memory 802 stores digital file metadata extractor 810 which is configured to extract metadata 820 from a digital file 720 that is being minted to form a digital asset 1010, such as an NFT or the like.

First memory 702 additionally stores digital asset power consumption optimization engine 830 that includes one or more Machine-Learning (ML) models 840, which may, in some embodiments of the invention, be Deep-Learning (DL) models or the like. Digital asset power consumption optimization engine 830 is configured to apply, at least, the extracted metadata 820 to the machine learning model(s) 840 to determine an optimal power consumption scheme 850 for minting 920 the digital asset 1010 from the digital file 720. The optimal power consumption may, in some instances, be the lowest possible power consumption, while, in other instances, other factors may be determinative of the optimal power consumption, such as geo-location of the distributed trust computing network 1000 at which the digital asset 1010 is minted.

System 700 additionally includes second computing platform 900, which includes second memory 902 and one or more second computing device processors 904 in communication with second memory 902. Second memory 902 stores digital asset minting application 910 that is executable by at least one of the second computing device processor(s) 904 and configured to receive the digital file 720 and mint 920 the digital asset 1010 from the digital file 720 in accordance with the optimal power consumption scheme 850.

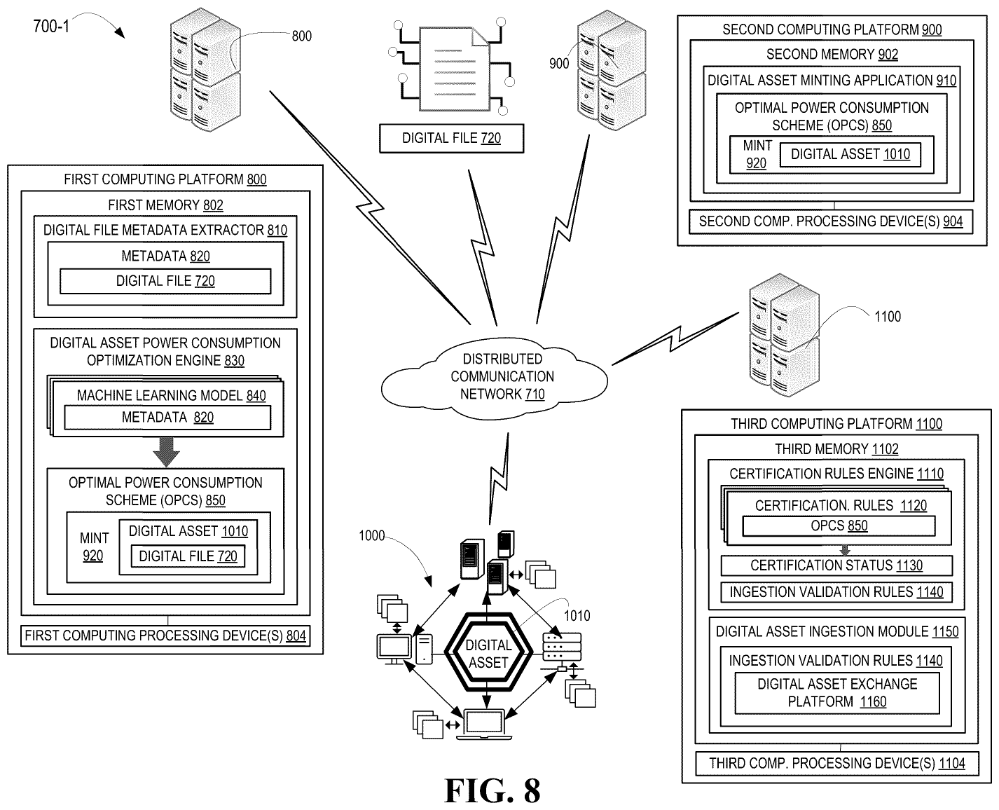

Referring to FIG. 8, a schematic/block diagram is presented of an alternative system 700-1 for minting and certifying digital assets, such as Non-Fungible Tokens (NFTs) with power consumption optimization, in accordance with embodiments of the present invention. In addition to the first and second computing platforms, shown and discussed in relation to FIG. 7, the alternative system 700-1 of FIG. 8 includes third computing platform 1100, which includes third memory 1102 and one or more third computing device processors 1104 in communication with third memory 1102. Third memory 1102 stores certification rules engine 1100 that is executable by at least one of the third computing processor device(s) 1104 and configured to select one or more of the plurality certification rules 1120 based at least on a type of the digital asset 1010, and, in response to selecting the certification rules 1120, apply at least the optimal power consumption scheme 850 to the selected certification rules 1120 to a determine a certification status 1130 for the digital asset 1010. Certification status indicates a level of power consumption used to mint the digital asset 1010 based on utilization of the optimal power consumption scheme 850 in minting 920 the digital asset 1010.

In specific embodiments of the system 7600-1, certification rules engine 1110 is further configured to, in response to determining the certification status 1130, generate a set of ingestion validate rules 1140 (e.g., “smart contract”). In such embodiments of the system 600-1, third memory 1102 may further store digital asset ingestion module 1150 that is executable by one or more of the third computing processor device(s) 1104 and configured to execute the set of ingestion rules 1140 to receive and validate the digital asset 1010 into a digit asset exchange platform 1160.

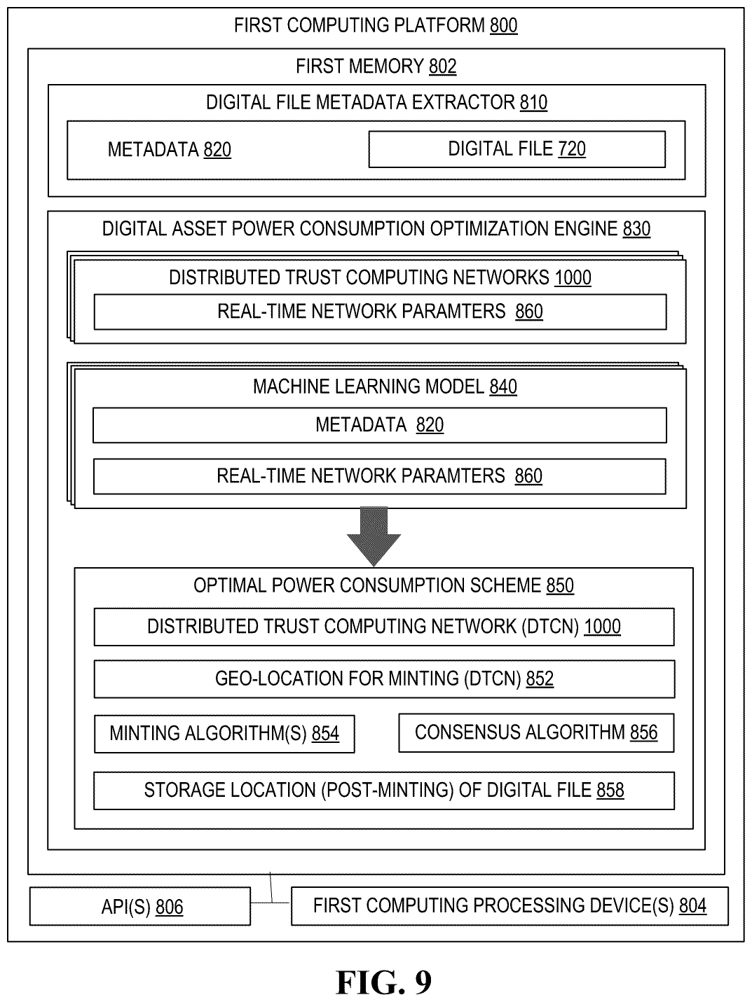

Referring to FIG. 9, a block diagram is presented of first computing platform 800, in accordance with embodiments of the present invention. In addition to providing greater details of digital asset power consumption optimization engine 830, FIG. 9 highlights various alternate embodiments of the invention. First computing platform 800 may comprise one or multiple devices, such as application servers or the like. First computing platform 800 includes first memory 802, which may comprise volatile and/or non-volatile memory, such as read-only and/or random-access memory (RAM and ROM), EPROM, EEPROM, flash cards, or any memory common to computing platforms). Moreover, first memory 802 may comprise cloud storage, such as provided by a cloud storage service and/or a cloud connection service.

Further, first computing platform 800 includes one or more first computing processing devices 804, which may be an application-specific integrated circuit (“ASIC”), or other chipset, logic circuit, or other data processing device. First computing processing device(s) 804 may execute one or more application programming interface (APIs) 806 that interface with any resident programs, such as digital file metadata extractor 810 and digital asset power consumption optimization engine 830 or the like, stored in first memory 802 of first computing platform 800 and any external programs. First computing processing devices(s) 804 may include various processing subsystems (not shown in FIG. 9) embodied in hardware, firmware, software, and combinations thereof, that enable the functionality of first computing platform 800 and the operability of first computing platform 800 on a distributed communication network 710 (shown in FIG. 7), such as the Internet, intranet(s), cellular network(s) and the like. For example, processing subsystems allow for initiating and maintaining communications and exchanging data with other networked devices. For the disclosed aspects, processing subsystems of first computing platform 800 may include any subsystem used in conjunction with digital file metadata extractor 810 and digital asset power consumption optimization engine 830 and related tools, routines, sub-routines, algorithms, sub-algorithms, sub-modules thereof.

In specific embodiments of the present invention, first computing platform 800 additionally includes a communications module (not shown in FIG. 9) embodied in hardware, firmware, software, and combinations thereof, that enables electronic communications between components of first computing platform 800 and other networks and network devices. Thus, communication module may include the requisite hardware, firmware, software and/or combinations thereof for establishing and maintaining a network communication connection with one or more devices and/or networks.

As discussed in FIG. 7, first memory 802 of first computing platform 800 stores digital file metadata extractor 810 and digital asset power consumption optimization engine 830, which are executable by at least one of the one or more first computing processor devices 804. As previously discussed in relation to FIG. 1, digital file metadata extractor 810 is configured to extract metadata 820 from the digital file 720 that is being minted 920 into a digital asset 1010. The metadata 820 may define digital characteristics of the digital file, which may be an image file, audio file, video file, entertainment file or the like.

In specific embodiments of the system 700, digital asset power consumption optimization engine 830 is configured to receive real-time (i.e., current) network parameters 860 from a plurality of different distributed trust computing networks 1000 and apply both the metadata 820 and the network parameters 860 to the machine-learning models 840 to determine the optimal power consumption scheme 850.

In specific embodiments of the system 700, the optimal power consumption scheme 850 includes a geo-location 852 for minting the digital asset 1010 and/or the distributed trust computing network 1000 for minting the digital asset 1010. Moreover, the optimal power consumption scheme 850 includes the minting algorithm(s) 854 and the consensus algorithm 856. In addition, in those instances in which the digital file 800 is stored in location other than the distributed trust computing network 1000 at which minting occurred, the optimal power consumption scheme 850 includes the storage location 858, post-minting, of the digital file.

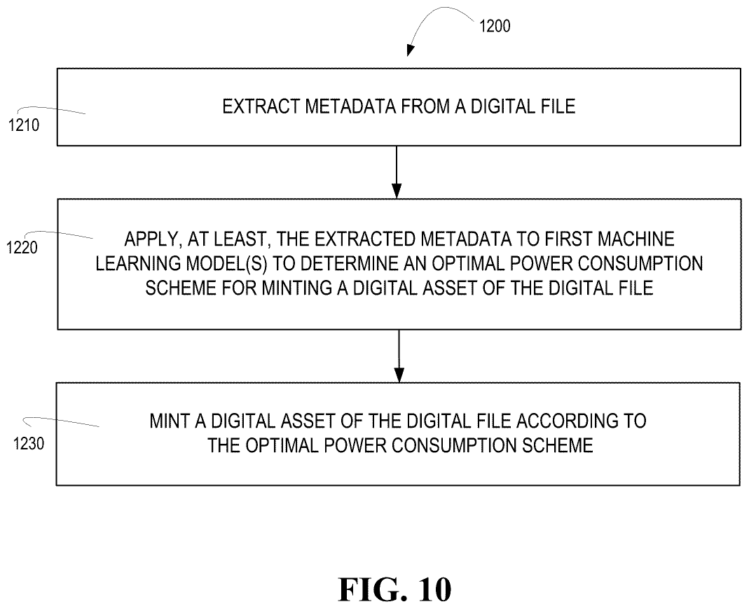

Referring to FIG. 10, a flow diagram is depicted of a method 1200 for minting digital assets with power consumption optimization, in accordance with embodiments of the present invention. At Event 1210 metadata is extracted from a digital file that is being minted into a digital asset, such as an NFT or the like. The metadata may include digital characteristics of the digital file, which may include an image file, an audio file, a video/multimedia file a entertainment file or the like.

At Event 1220, at least the extracted metadata is applied on machine-learning model(s) to determine an optimal power consumption scheme for minting the digital asset from the digital file. In specific embodiments of the method, current distributed trust computing network parameters from various different distributed trust computing networks are received and also applied to the machine learning models to determine the optimal power consumption scheme. The optimal power consumption scheme may define the geo-location for minting and/or the distributed trust computing network at which minting occurs, the minting algorithm(s), the consensus/validation algorithm(s) and the like. The optimal power consumption scheme may, in some instances, provide for the lowest possible power consumption, while, in other instances, other factors may be determinative of the optimal power consumption, such as geo-location of the distributed trust computing network at which the digital asset is minted.

At Event 1230, the digital asset is minted from the digital file in accordance with the optimal power consumption scheme. In specific embodiments of the method, in which the digital file is not stored on the same distributed trust computing network at which the digital asset was minted, the digital file, post-minting, is filed at a storage location as defined by the optimal power consumption scheme.

Thus, present embodiments of the invention discussed in detail above, provide for intelligently provides for intelligent validation of digital resources through power consumption telemetry tracking. In this regard, the present invention is capable of extracting, from distributed trust computing networks and the like, power consumption telemetry data associated with a digital asset. The extracted power consumption telemetry data is applied to ML models to determine a power consumption indicator. Subsequently, a validation rules engine is executed, which selects validation rules based at least on digital asset type and applies, at least, the power consumption indicator to the selected validation rules to determine validation status. The validation status, which may be partially based on a minimal power consumption threshold, is determinative as to whether or not the digital asset is authorized for acceptance into a digital asset exchange platform. In the event that the digital asset is capable of being validated, in specific embodiments of the invention, the digital asset exchange platform may classify and tag the digital asset according to levels of power consumption, so that subsequent exchanges involving the digital asset can be managed based on the classification and/or tagging.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for intelligently validating digital assets, the system comprising:
a first computing platform including a first memory and one or more first computing processor devices in communication with the first memory, wherein the first memory stores:
a digital asset telemetry extractor executable by at least one of the one or more first computing processor devices and configured to:
extract telemetry data related to power consumed during minting or mining of a digital asset, and
a digital asset power consumption evaluation engine including one or more machine learning models, executable by at least one of the one or more first computing processor devices and configured to:
apply the extracted telemetry data to the one or more machine learning models to determine a power consumption indicator for the digital asset; and
a second computing platform including a second memory and one or more second computing processor devices in communication with the second memory, wherein the second memory stores:
a validation rules engine including a plurality of validation rules, executable by at least one of the one or more second computing processor devices and configured to:
select one or more of the plurality validation rules based at least on a type of the digital asset,
apply at least the power consumption indicator to the selected one or more validation rules to determine a validation status of the digital asset, wherein the validation status is one of (i) authorized for digital asset exchange platform ingestion, or (ii) unauthorized for digital asset exchange platform ingestion
in response to determining the validation status as authorized for digital asset exchange platform ingestion, generate a set of ingestion validation rules, and
a digital asset ingestion module executable by at least one of the one or more second computing processor devices and configured to:
execute the set of ingestion rules to receive and validate the digital asset into a digit asset exchange platform.

2. The system of claim 1, wherein the digital asset telemetry extractor is further configured to extract telemetry data related to power consumed during minting of a digital asset, wherein the telemetry data includes data associated with (i) a first distributed trust computing network used to mint the digital asset, (ii) type of consensus algorithm used to mint the digital asset, (iii) identification and type of nodes used to mint the digital asset, and (iv) geo-location of the first distributed trust computing network and nodes used to mint the digital asset.

3. The system of claim 2, wherein the digital asset telemetry extractor is further configured to extract telemetry data related to power consumed during transfer of the digital asset, wherein the telemetry data includes data associated with (i) one or more secondary distributed trust computing networks to which the digital asset has been transferred, and (ii) one or more cross-bridges used to transfer the digital asset amongst the first distributed trust computing network and the one or more secondary distributed trust computing networks, (iii) type of consensus algorithms used to validate the digital asset at the one or more secondary distributed trust computing networks, (iv) identification and type of nodes used to validate the digital asset at the one or more secondary distributed trust computing networks, and (v) geo-location of the one or more secondary distributed trust computing network and nodes used to validate the digital asset at the one or more secondary distributed trust computing networks.

4. The system of claim 1, wherein the digital asset telemetry extractor is further configured to extract telemetry data related to power consumed during mining of a digital asset, wherein the telemetry data includes data associated with (i) a first distributed trust computing network used to mine the digital asset, (ii) type of proof-of-work (PoW) algorithm used to mine the digital asset, (iii) identification and type of node used to mine the digital asset, and (iv) geo-location of the first distributed trust computing network and node used to mine the digital asset.

5. The system of claim 1, wherein the digital asset power consumption evaluation engine including one or more machine learning models, wherein at least one of the machine learning models is a deep learning model comprising at least one chosen from the group consisting of knowledge graph, Natural Language Processing (NLP) and Generative Adversarial Network (GAN).

6. The system of claim 1, wherein the digital asset power consumption evaluation engine is further configured to apply the extracted telemetry data to the one or more machine learning models which maps the extracted telemetry data to weighted power consumption parameters that are aggregated to result in the power consumption indicator in a form of a power consumption score.

7. The system of claim 1, wherein the validation rules engine is further configured to apply the power consumption indicator and other extracted telemetry data to the selected one or more validation rules to determine validation of the digital asset, wherein the other extracted telemetry data includes at least one of geo-location of (i) a distributed trust computing network at which the digital asset has been minted or mined and (ii) nodes within the distributed trust computing network used to mint or mine the digital asset.

8. The system of claim 1, wherein the digital asset ingestion module is further configured to, in response to ingesting the digital asset into a digit asset exchange platform, classify the digital asset based on the power consumption indicator and assign an index tag based on the classification.

9. The system of claim 8, wherein second memory further stores a digital asset management rules engine executable by at least one of the one or more second computing processor devices and configured to manage exchanges involving the digital asset based on the index tag assigned to the digital asset.

10. A computer-implemented method for intelligently validating digital assets, the method being executable by one or more computing device processors and comprising:
extracting telemetry data related to power consumed during minting or mining of a digital asset;
applying the extracted telemetry data to one or more machine learning models to determine a power consumption indicator for the digital asset;
selecting one or more validation rules from amongst a plurality of validation rules based at least on a type of the digital asset;
applying at least the power consumption indicator to the selected one or more validation rules to determine a validation status of the digital asset, wherein the validation status is one of (i) authorized for digital asset exchange platform ingestion, or (ii) unauthorized for digital asset exchange platform ingestion;
in response to determining the validation status as authorized for digital asset exchange platform ingestion, generating a set of ingestion rules; and
executing the set of ingestion rules to ingest the digital asset into a digit asset exchange platform.

11. The computer-implemented method of claim 10, wherein extracting the telemetry data related to power consumed during minting of a digital asset, further comprises extracting the telemetry data including data associated with (i) a first distributed trust computing network used to mint the digital asset, (ii) type of consensus algorithm used to mint the digital asset, (iii) identification and type of nodes used to mint the digital asset, and (iv) geo-location of the first distributed trust computing network and nodes used to mint the digital asset.

12. The computer-implemented method of claim 11, wherein extracting telemetry data further comprises extracting the telemetry data related to power consumed during transfer of the digital asset including data associated with (i) one or more secondary distributed trust computing networks to which the digital asset has been transferred, and (ii) one or more cross-bridges used to transfer the digital asset amongst the first distributed trust computing network and the one or more secondary distributed trust computing networks, (iii) type of consensus algorithms used to validate the digital asset at the one or more secondary distributed trust computing networks, (iv) identification and type of nodes used to validate the digital asset at the one or more secondary distributed trust computing networks, and (v) geo-location of the one or more secondary distributed trust computing network and nodes used to validate the digital asset at the one or more secondary distributed trust computing networks.

13. The computer-implemented method of claim 10, wherein applying the extracted telemetry data to the one or more machine learning models further comprises mapping the extracted telemetry data to weighted power consumption parameters and aggregating the weighted power consumption parameters to result in the power consumption indicator in a form of a power consumption score.

14. The computer implemented method of claim 10, further comprising:
in response to ingesting the digital asset into a digit asset exchange platform, classifying the digital asset based on the power consumption indicator and assigning an index tag based on the classification.

15. The computer-implemented method of claim 14, further comprising:
managing exchanges involving the digital asset based on the index tag assigned to the digital asset.

16. A computer program product comprising:
a non-transitory computer-readable medium comprising sets of codes for causing one or more computing devices to:
extract telemetry data related to power consumed during minting or mining of a digital asset;
apply the extracted telemetry data to one or more machine learning models to determine a power consumption indicator for the digital asset;
select one or more validation rules from amongst a plurality of validation rules based at least on a type of the digital asset;
apply at least the power consumption indicator to the selected one or more validation rules to determine a validation status of the digital asset, wherein the validation status is one of (i) authorized for digital asset exchange platform ingestion, or (ii) unauthorized for digital asset exchange platform ingestion;
in response to determining the validation status as authorized for digital asset exchange platform ingestion, generate a set of ingestion rules; and
execute the set of ingestion rules to ingest the digital asset into a digit asset exchange platform.

17. The computer program product of claim 16, wherein the set of codes for causing the one or more computing devices to extract telemetry data related to power consumed during minting or mining of a digital asset are further configured to cause the one or more computing devices to extract the telemetry data including data associated with (i) a first distributed trust computing network used to mint the digital asset, (ii) type of consensus algorithm used to mint the digital asset, (iii) identification and type of nodes used to mint the digital asset, and (iv) geo-location of the first distributed trust computing network and nodes used to mint the digital asset.

18. The computer program product of claim 17, wherein the set of codes for causing the one or more computing devices to extract telemetry data are further configured to cause the one or more computing devices to extract the telemetry data related to power consumed during transfer of the digital asset including data associated with (i) one or more secondary distributed trust computing networks to which the digital asset has been transferred, and (ii) one or more cross-bridges used to transfer the digital asset amongst the first distributed trust computing network and the one or more secondary distributed trust computing networks, (iii) type of consensus algorithms used to validate the digital asset at the one or more secondary distributed trust computing networks, (iv) identification and type of nodes used to validate the digital asset at the one or more secondary distributed trust computing networks, and (v) geo-location of the one or more secondary distributed trust computing network and nodes used to validate the digital asset at the one or more secondary distributed trust computing networks.

19. The computer program product of claim 16, wherein the set of codes for causing the one or more computing devices to apply the extracted telemetry data to the one or more machine learning models are further configured to cause the one or more computing devices to map the extracted telemetry data to weighted power consumption parameters and aggregate the weighted power consumption parameters to result in the power consumption indicator in a form of a power consumption score.

20. The computer program product of claim 16, wherein the sets of codes further comprise a set of codes for causing the one or more computing devices to:
in response to ingesting the digital asset into a digit asset exchange platform, classify the digital asset based on the power consumption indicator and assign an index tag based on the classification; and
manage exchanges involving the digital asset based on the index tag assigned to the digital asset.
